(19) United States
(12) Patent Application Publication
(10) Pub. No.: US 2025/0274377 A1
(43) Pub. Date: Aug. 28, 2025

(54) SYSTEMS AND METHODS FOR ETHERNET NETWORK DEVICE EMULATOR

(71) Applicant: Rockwell Automation Technologies, Inc., Mayfield Heights, OH (US)

(72) Inventors: Jakub Korbel, Praha (CZ); Jakub Malý, Pilsen (CZ)

(21) Appl. No.: 18/588,518

(22) Filed: Feb. 27, 2024

(51) Int. Cl. H04L 43/55; G06F 11/26

(52) U.S. Cl. CPC H04L 43/55; G06F 11/261

(57) ABSTRACT

A non-transitory computer-readable medium comprising computer-executable instructions that, when executed, may cause processing circuitry to perform operations including receiving, at a communications stack of an operating system, communications from one or more industrial automation devices. The operations may also include identifying a subset of the communications, wherein the subset of the communications comprises one or more low-level communication frames and forwarding the remaining communications to the operating system. Further, the operations may include determining a networking operation indicated by the low-level communication frames and transmitting the one or more low-level communication frames to one or more simulated industrial automation devices according to the determined networking operation.

### BACKGROUND

This disclosure generally relates to systems and methods for testing devices of industrial automation systems. More particularly, embodiments of the present disclosure are directed toward providing emulation capabilities for testing industrial automation devices.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light and not as admissions of prior art.

Industrial automation systems may include a wide range of devices, such as valves, electric motors, various types of sensors, other suitable monitoring devices, or the like. These devices may include firmware that facilitates low-level (e.g., Layer 2, data link layer) network communications of the device. The firmware be tested to ensure proper development and integration with a connected system. However, physical testing may be made challenging by hardware shortages, supply chain issues, and so on. Further, testers may wish to protect an actual network and/or other devices operating on the network to certain vulnerabilities associated with physical testing. Devices of an industrial automation system may instead be tested virtually (e.g., emulated) using high-level operating systems, such as those that run on a personal computing device. However, testing low-level communications using high-level operating systems may prove challenging.

### SUMMARY

A summary of certain embodiments disclosed herein is set forth below. It should be understood that these aspects are presented merely to provide the reader with a brief summary of these certain embodiments and that these aspects are not intended to limit the scope of this present disclosure. Indeed, this present disclosure may encompass a variety of aspects that may not be set forth below.

In one embodiment, a non-transitory computer-readable medium comprising computer-executable instructions that, when executed, may cause processing circuitry to perform operations including receiving, at a communications stack of an operating system, communications from one or more industrial automation devices. The operations may also include identifying a subset of the communications, wherein the subset of the communications comprises one or more low-level communication frames and forwarding the remaining communications to the operating system. Further, the operations may include determining a networking operation indicated by the low-level communication frames and transmitting the one or more low-level communication frames to one or more simulated industrial automation devices according to the determined networking operation.

In another embodiment, a system includes processing circuitry and a storage. The storage may store code defining an operating system and a kernel module including instructions that, when executed by the processing circuitry, cause the processing circuitry to receive, at a communications stack of the operating system, communications from one or more industrial automation devices. The instructions may also cause the processing circuitry to identify a subset of the communications, wherein the subset of the communications comprises one or more low-level communication frames, forward the remaining communications to the operating system, determine a networking operation indicated by the low-level communication frames, and transmit the one or more low-level communication frames to one or more simulated industrial automation devices according to the networking operation.

In yet another embodiment, a method, includes receiving, at a communications stack of an operating system, communications from one or more industrial automation devices, identifying a subset of the communications, wherein the subset of the communications comprises one or more low-level communication frames. The method also includes forwarding the remaining communications to the operating system, determining that one or more applications are registered to receive the one or more low-level communication frames, and transmitting the one or more low-level communication frames to a simulated industrial automation device of each of the one or more applications.

### BRIEF DESCRIPTION OF THE DRAWINGS

These and other features, aspects, and advantages of the present disclosure may become better understood when the following detailed description is read with reference to the accompanying drawings in which like characters represent like parts throughout the drawings, wherein:

FIG. 1 illustrates an example industrial automation system employed by a food manufacturer, in accordance with an embodiment;

FIG. 2 illustrates a diagrammatical representation of an exemplary network device emulator system that may be employed in any suitable industrial automation system, including the industrial automation system of FIG. 1, in accordance with an embodiment;

FIG. 3 illustrates communication pathways of the network device emulator system of FIG. 2, employed with a network of an industrial automation system, in accordance with an embodiment;

FIG. 4A illustrates a flow chart of a process for registering application connectors at a kernel module of the network device emulator system of FIG. 2, in accordance with an embodiment;

FIG. 4B illustrates a flow chart of a process for receiving and executing commands received from an application connector managed by the kernel module of the network device emulator system of FIG. 2, in accordance with an embodiment;

FIG. 4C illustrates a flow chart of a process for performing additional emulation functions at the kernel module of the network device emulator system of FIG. 2, in accordance with an embodiment;

FIG. 5A illustrates a flow chart of a process for receiving data from the kernel module that may be performed by an application connector to emulate an industrial automation device within the industrial automation system of FIG. 1, in accordance with an embodiment; and

FIG. 5B illustrates a flow chart of a process for interfacing with an application that may be performed by the application connector during emulation of the industrial automation device within the industrial automation system of FIG. 1, in accordance with an embodiment,

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions are made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As mentioned above, industrial automation systems may include a wide range of devices, such as valves, electric motors, various types of sensors, other suitable monitoring devices, or the like. These devices may communicate with other devices on a network (e.g., an operational technology (OT) network), connected automation control and monitoring systems, and the like using a low-level communications protocol, such as Ethernet. Further, each device of an industrial automation system may include firmware that facilitates low-level network communications between devices. This firmware may be periodically updated to, for example, change communications or security configurations of a device, allow additional functionalities and/or features for the device, and so on.

To ensure proper development and integration of device firmware, the firmware may be tested by, for example, monitoring communications sent to, or received from, the device. This may be accomplished, for example, by physical connection of the industrial automation device to a testing device, a personal computer, or the like. However, such physical testing may be made challenging by hardware shortages (e.g., shortages of testing devices), transportation of devices between testing location and industrial automation systems, supply chain shortages, and so on. Further, testing software may be incapable of properly testing aspects of low-level network communications or the firmware components that facilitate such communications.

Accordingly, as will be described in more detail below, the present disclosure is generally directed towards systems and methods that allow emulation and testing of low-level communication capabilities of an industrial automation device. In some embodiments, a low-level network device emulator system may include a kernel module on a firewall layer (e.g., kernel space) of an operating system kernel. The kernel module may be loaded and unloaded from the kernel, such that it may interface with the kernel in a non-destructive, secure manner. Additionally, the kernel may communicate with one or more user-space application connectors, each of which may be part of a network device emulator application.

The kernel module may intercept low-level communication frames, such as Ethernet frames, from a TCP/IP stack of the operating system, allowing full control of frames communicated to the operating system. The low-level network communications may originate from one of the user-space application connectors and may include, for example, commands related to registering simulated devices, receiving frames, or transmitting frames. Further, the low-level network communications may correspond to network communications to and from an industrial automation device, allowing characterization (e.g., emulation) of communication aspects of the device. The kernel module may, upon receiving a command, authenticate a device address (e.g., MAC address) of a simulated or physical device before executing the command.

In some embodiments, the user-space application connector may be used for testing purposes in place of a network interface controller driver of a (real) industrial automation device. The user-space application connector may include an API and, when the API is called, the connector may send a command to the kernel module to perform an operation. For example, the connector may wake up (e.g., link up) or disappear (e.g., link down) on a connected network, send a frame to the network, fetch a frame from the network, or perform other networking functions of an embedded device.

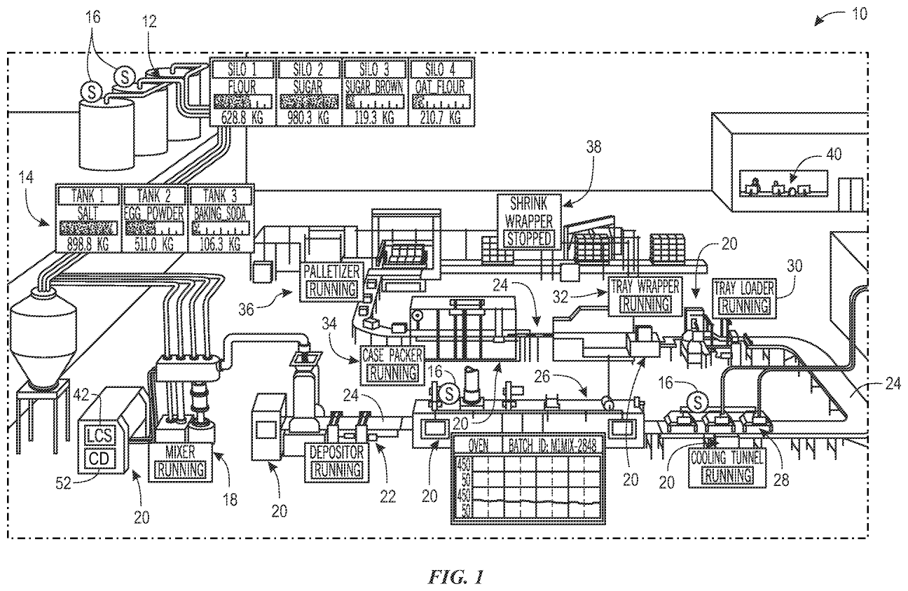

By way of introduction, FIG. 1 illustrates an example industrial automation system 10 employed by a food manufacturer. It should be noted that although the example industrial automation system 10 of FIG. 1 is directed at a food manufacturer, the present embodiments described herein may be employed within any suitable industry, such as automotive, mining, hydrocarbon production, manufacturing, and the like. The following brief description of the example industrial automation system 10 employed by the food manufacturer is provided herein to help facilitate a more comprehensive understanding of how the embodiments described herein may be applied to industrial devices to significantly improve the operations of the respective industrial automation system. As such, the embodiments described herein should not be limited to be applied to the example depicted in FIG. 1.

Referring now to FIG. 1, the example industrial automation system 10 for a food manufacturer may include silos 12 and tanks 14. The silos 12 and the tanks 14 may store different types of raw material, such as grains, salt, yeast, sweeteners, flavoring agents, coloring agents, vitamins, minerals, and preservatives. In some embodiments, sensors 16 may be positioned within or around the silos 12, the tanks 14, or other suitable locations within the industrial automation system 10 to measure certain properties, such as temperature, mass, volume, pressure, humidity, and the like.

The raw materials may be provided to a mixer 18, which may mix the raw materials together according to a specified ratio. The mixer 18 and other machines in the industrial automation system 10 may employ certain industrial automation devices 20 to control the operations of the mixer 18 and other machines. The industrial automation devices 20 may include controllers, input/output (I/O) modules, motor control centers, motors, human machine interfaces (HMIs), operator interfaces, contactors, starters, sensors 16, actuators, conveyors, drives, relays, protection devices, switchgear, compressors, sensor, actuator, firewall, network switches (e.g., Ethernet switches, modular-managed, fixed-managed, service-router, industrial, unmanaged, etc.) and the like.

The mixer 18 may provide a mixed compound to a depositor 22, which may deposit a certain amount of the mixed compound onto conveyor 24. The depositor 22 may deposit the mixed compound on the conveyor 24 according to a shape and amount that may be specified to a control system for the depositor 22. The conveyor 24 may be any suitable conveyor system that transports items to various types of machinery across the industrial automation system 10. For example, the conveyor 24 may transport deposited material from the depositor 22 to an oven 26, which may bake the deposited material. The baked material may be transported to a cooling tunnel 28 to cool the baked material, such that the cooled material may be transported to a tray loader 30 via the conveyor 24. The tray loader 30 may include machinery that receives a certain amount of the cooled material for packaging. By way of example, the tray loader 30 may receive 25 ounces of the cooled material, which may correspond to an amount of cereal provided in a cereal box.

A tray wrapper 32 may receive a collected amount of cooled material from the tray loader 30 into a bag, which may be sealed. The tray wrapper 32 may receive the collected amount of cooled material in a bag and seal the bag using appropriate machinery. The conveyor 24 may transport the bagged material to case packer 34, which may package the bagged material into a box. The boxes may be transported to a palletizer 36, which may stack a certain number of boxes on a pallet that may be lifted using a forklift or the like. The stacked boxes may then be transported to a shrink wrapper 38, which may wrap the stacked boxes with shrink-wrap to keep the stacked boxes together while on the pallet. The shrink-wrapped boxes may then be transported to storage or the like via a forklift or other suitable transport vehicle.

To perform the operations of each of the devices in the example industrial automation system 10, the industrial automation devices 20 may be used to provide power to the machinery used to perform certain tasks, provide protection to the machinery from electrical surges, prevent injuries from occurring with human operators in the industrial automation system 10, monitor the operations of the respective device, communicate data regarding the respective device to a supervisory control system 40, and the like. In some embodiments, each industrial automation device 20 or a group of industrial automation devices 20 may be controlled using a local control system 42. The local control system 42 may receive data regarding the operation of the respective industrial automation device 20, other industrial automation devices 20, user inputs, and other suitable inputs to control the operations of the respective industrial automation device(s) 20. Additionally, the respective automation device 20 may be communicatively coupled to a computing device 52, and the computing device 52 may test software and hardware components of the respective automation device 20. For example, the computing device 52 may store and execute testing software that communicates with and evaluates firmware of the respective automation device 20.

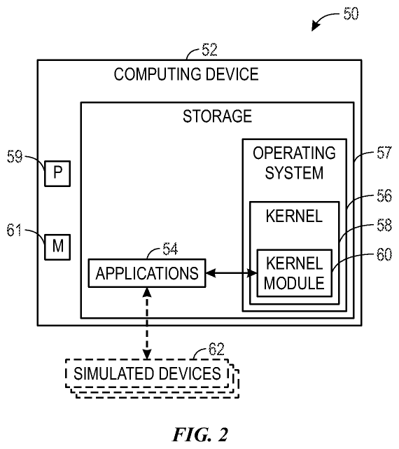

FIG. 2 illustrates a diagrammatical representation of an exemplary network device emulator system 50 that may be employed in any suitable industrial automation system 10, or to test an industrial automation device prior to installation in an industrial automation system 10, in accordance with embodiments presented herein. In FIG. 2, network device emulator system 50 is illustrated as including the computing device 52 storing code defining one or more applications 54 and an operating system 56 in, for example, a storage 57 for execution by one or more processors 59 of the computing device 52. The operating system 56 may include a kernel 58 that may facilitate process management, memory management, hardware management, and so on of the computing device 52. As used herein, a “kernel”, such as the kernel 58, may be understood to mean a core component of an operating system that facilitates communication and coordination between system components. For example, the kernel 58 may control access to hardware resources of the computing device 52, such as the one or more processors 59 and a memory 61. Additionally, in the illustrated embodiment, the kernel 58 may include a kernel module 60, which may include one or more software hooks that facilitate communication between the applications 54 and the operating system 56. As used herein, a “kernel module”, such as the kernel module 60, may be understood to mean a code component (e.g., an object file) that may be loaded and unloaded from a kernel as needed to further kernel functionality. In particular, as will be described in more detail below, the kernel module 60 may allow the interception of low-level communications (e.g., Layer 2, data link layer) to and from the kernel 58 of the operating system 56. In some embodiments, the kernel 58 and/or the kernel module 60 may be loaded onto the memory 61 based on instructions from the applications 54, the operating system 56, elsewhere, or some combination thereof. For example, the kernel module 60 and/or the kernel 58 may be placed in the memory 61 such that the kernel module 60 may be selectively loaded and unloaded from the kernel 58.

The one or more applications 54 may facilitate user-space input and representation (e.g., via a display of the computing device 52). Additionally, the applications 54 may include binaries, libraries, and the like as one or more simulated devices 62, which may represent various types of devices of the industrial automation system 10, such as industrial automation devices 20 (e.g., drives, controllers, and so forth), the mixer 18, the depositor 22, the conveyor 24, the oven 26, edge devices, and the other pieces of machinery described in FIG. 1. The simulated devices 62 may include, for example, programming objects (e.g., “digital twins”) that may be instantiated and executed to provide simulated functionality similar or identical to the actual components, visualization of the components, or both. In particular, each simulated device 62 may include substantially similar software of a corresponding device (e.g., physical device) of the industrial automation system 10, such as firmware used for low-level communications and functionality of the device.

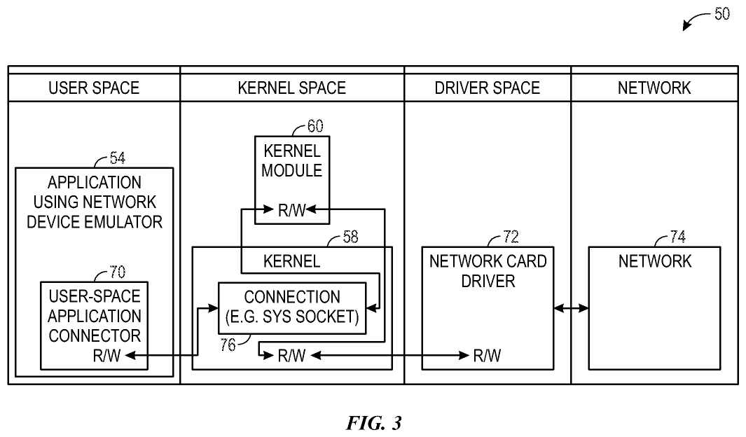

FIG. 3 is a diagram of communications of the network device emulator system 50 employed with a network card driver 72 and a network 74. The network card driver 72 may facilitate communications between the kernel module 60 and industrial automation devices (e.g., the devices 20 of FIG. 1) of a network 74. As illustrated in FIG. 3, each application 54 includes an application connector 70, and each application connector 70 may act as a network driver for the application 54. That is, the application connector 70 may perform functionalities for a simulated device 62 of the application 54 similar to the functionalities performed by a network driver 72 for a physical device of a network 74. For example, the application connector 70 may be embedded within (e.g., included as part of) the application 54, and may include a compact software library that, when executed, performs networking functions for a simulated device 62 of the application 54. In some embodiments, the application connector 70 may be executed when an API of the application connector 70 is called by the application 54 to perform an operation. The operations may include networking operations, such as waking up on a network (e.g., linking up, registering a connector), disappearing on a network (e.g., linking down, cancelling a connector registration), sending a frame to a network, receiving a snatched frame, and so on, as will be described below. As may be appreciated, the networking operations performed by a simulated device 62 may correspond to networking operations performed by the firmware of a physical industrial automation device. Additionally, the application connector 70 may determine whether to communicate with the kernel module 60 to perform networking operations when called by the application 54.

The kernel module 60 may, via a connection 76 be embedded within the kernel 58, receive commands from the application connector 70 and execute them. In some embodiments, the operating system 56 may include a Transmission Control Protocol/Internet Protocol (TCP/IP) stack that may contain high-level and low-level communications received from a network of industrial automation devices. For example, the low-level communications of the TCP/IP stack may include commands corresponding to networking operations of one or more devices, the simulated devices 62, or both. Further, because the kernel module 60 and connection 76 may operate entirely within a firewall layer of the kernel 58, the kernel module 60 may snatch low-level communication frames before manipulation and/or processing by the operating system 56. As used herein, to “snatch” communications (e.g., low-level frames) sent to a host operating system may be understood to mean routing or processing the communications before the communications reach the host operating system. As such, communications from the simulated device 62 may be properly processed by the kernel module 60 without interference from the operating system, and the kernel module 60 may thus be allowed control of incoming networking commands and other low-level communications. Further, the connection 76 may mediate communication between the application 54 and the kernel module 60 such that the application 54 has limited privileges and/or access to the operating system 56 and may include Netlink sockets, named pipes, or other suitable secure connections. This may further allow the simulated device 62 to properly emulate a corresponding device, as communications from the application 54 may be prevented from impacting, for example, debugging software facilitated by the operating system 56.

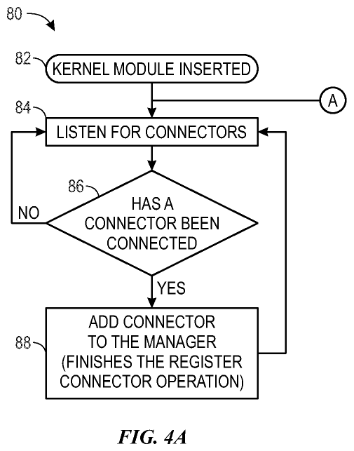

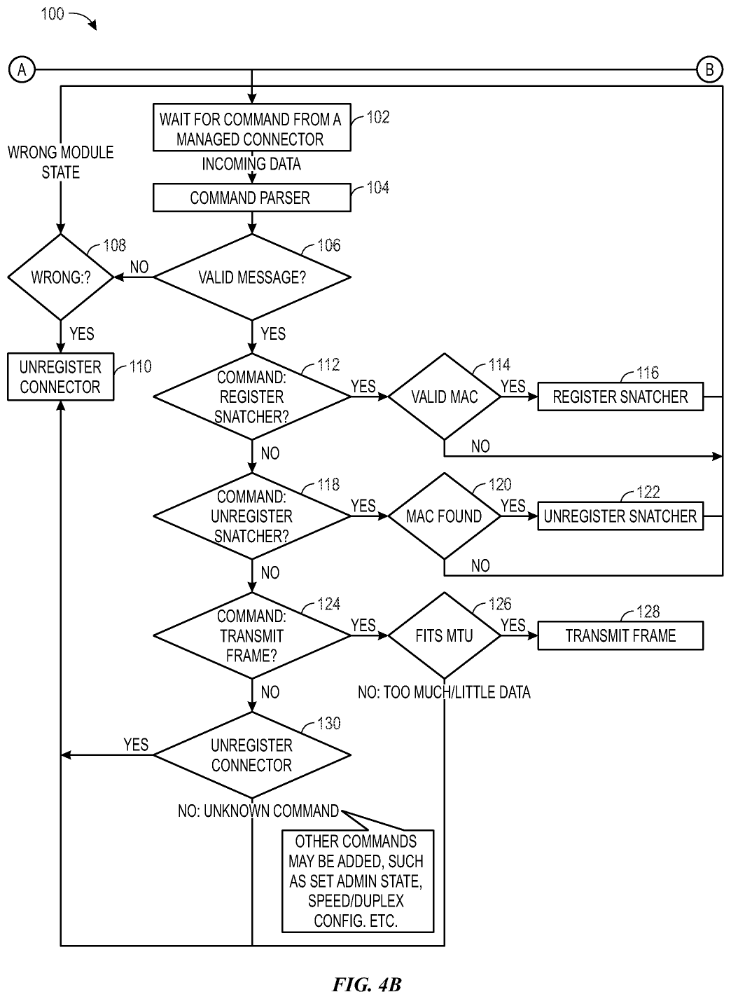

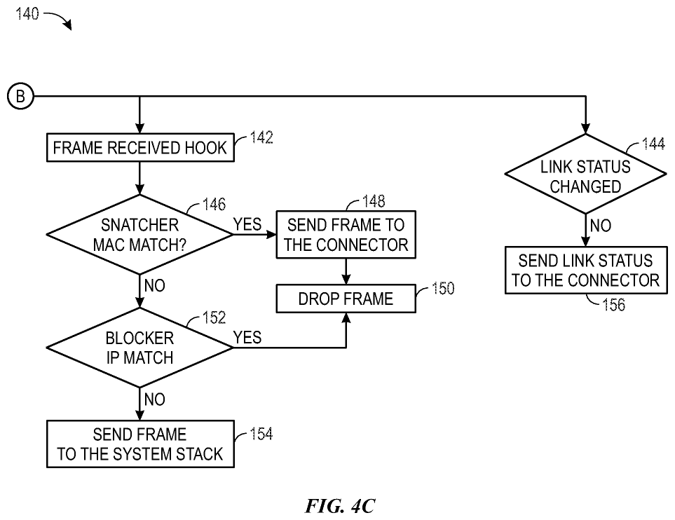

The kernel module 60 may register and manage multiple connections 76 to facilitate communications with multiple application connectors 70. FIG. 4A illustrates a flow chart of a process 80 for registering application connectors (e.g., the application connector 70) at a kernel module (e.g., the kernel module 60). The process 80 may begin, in block 82, with inserting the kernel module within a kernel of an operating system (e.g., the kernel 58 of the operating system 56). This may include, for example, inserting one or more software hooks at locations within the kernel of the operating system. Insertion of the kernel module may cause the kernel module to be called (e.g., hooked to) when, for example, communications are received at the kernel, such that the kernel module may receive communications or portions of the communications (e.g., low-level communications) before processing by the kernel or other elements of the operating system. As mentioned, the kernel module 60 may be structured such that it may be loaded and unloaded from the kernel 58 as needed. Further, while the kernel module 60 may snatch certain low-level communications (e.g., networking commands), it may forward other communications (e.g., high-level communications) to the operating system 56, which may cause high-level communications of the operating system 56 to function normally (e.g., as if the kernel module 60 was absent from the kernel 58).

Once the kernel module is inserted into the kernel, the kernel module may listen for application connectors in block 84. In particular, the kernel module 60 may snatch low-level communications from the TCP/IP stack of the operating system as communications are received at the TCP/IP stack. As discussed, the snatched low-level communications may include frames indicative of commands that may correspond to networking operations of one or more applications connectors. If, in block 86, the low-level communications do not include a command to connect an application connector, the kernel module may continue to monitor the TCP/IP stack for low-level communications indicative of such instructions in block 84.

If, however, the kernel module snatches low-level communications indicative of a valid connection attempt an application connector, in block 88, the application connector is added to a connector manager of the kernel module. A valid connection attempt may include, for example, a communication channel descriptor, which may store data required for communication between an application connector and the kernel module, and a connector address (e.g., MAC address) of the application connector. The communication channel descriptor and connector address may be received as an opaque data type, and may be added to a connector registry of the kernel module, completing the register connector operation of the application connector. In some embodiments, registration of an application connector may include an allocation of data for network communications of the application connector. After the application connector is registered by the kernel module, the process 80 may continue, in block 84, by listening for additional connection attempts. That is, the kernel module may sequentially register multiple application connectors and add each application connector to the connector registry. In some embodiments, the kernel module may simultaneously register multiple application connectors using, for example, multiple connections (e.g., multiple connections 76) and/or multiple TCP/IP stacks.

FIG. 4B is a flow chart of a process 100 for receiving and executing commands received from an application connector managed by the kernel module, such as an application connector 70 registered as part of the process 80 of FIG. 4A. The process 100 may be performed by the kernel module after the kernel module is inserted to the kernel, as illustrated in block 82 of the process 80. In some embodiments, the process 100 may be performed in parallel (e.g., simultaneously) with the process 80 after the kernel module is inserted in block 82. After the kernel module is inserted, the process 100 may continue, in block 102, by waiting for a command from a connector managed by the kernel module (e.g., registered in the connector registry). This may include, for example, monitoring incoming data at the TCP/IP stack of the operating system for low-level communications indicative of networking commands.

When a command is detected in the incoming data, in block 104, the command may be parsed for validity by the kernel module. Validity may be determined by the kernel module based on a format and/or size of a data frame of the command and/or expected values of parameters of the command. For example, the kernel module may determine whether an identifier of the command is unknown, whether a data size of the command corresponds to the identifier of the command, whether one or more parameters of the command correspond to the identifier of the command, and so on. If, in block 106, the command is determined not to be a valid message, in block 108, the kernel module determines whether the command is of the wrong format or if the kernel module, a connector, and/or a snatcher are in an invalid state for the command. An invalid state may be determined if the command includes a request to unregister a connector that is not registered, for instance. If the kernel module, a connector, and/or a snatcher are in an invalid state, the kernel module may continue waiting for commands from managed connectors in block 102. If, however, the command is of the wrong format, the connector from which the command originated (e.g., as identified by a MAC address included with the command), the connector may be unregistered by, for example, removing the communication channel descriptor and MAC address associated with the connector from the connector registry.

Returning to block 106, if the command is determined to be valid, the kernel module may determine which networking operation the command corresponds to. The following networking operations may be determined in any order, and one or more of the networking operations may be omitted from the process 100. In the illustrated example, in block 112, the kernel module may determine whether the command includes a request to register a snatcher for the connector from which the command originated. As used herein, a “snatcher” may be used at the kernel module to route incoming communications to one or more designated application connectors before they reach a host operating system. If the command includes a request to register a snatcher, in block 114, the MAC address of the application connector from which the command originated is checked by the kernel module for validity, which may include referencing the connector registry to confirm that a MAC address associated with the command is present. If the MAC address associated with the command is determined to not be valid (e.g., a MAC address associated with the command is not listed in the connector registry), the kernel module may continue monitoring for commands from a managed connector, as represented by block 102. If the MAC address associated with the command is determined to be valid, in block 116, the snatcher is registered for the application connector from which the command originated. This may include adding an indication that the application connector includes a snatcher to the existing connector registry or adding such an indication to a separate snatcher registry, as examples. In any case, registration of a snatcher for a registered application connector may cause low-level communications to be routed to the application connector before reaching the host operating system.

If, in block 112, the command is determined not to include a request to register a snatcher, the kernel module may determine whether the command includes a request to unregister a snatcher for an application connector in block 118. If the kernel module determines that the command does correspond to a request to unregister a snatcher, in block 120, the connector registry and/or a snatcher registry may be searched for a MAC address indicated by the command. If the MAC address is found, in block 122, the snatcher for the application connector having the MAC address is unregistered. This may include, for example, removing an indication of the snatcher from the connector registry, snatcher registry, or both. As may be appreciated, communications may no longer be redirected to the application connector once the snatcher is unregistered. If, in block 120, the MAC address cannot be found by the kernel module, the kernel module may continue waiting for commands from managed connectors in block 102.

Moving on, if the command is not determined to include a request to unregister a snatcher, the kernel module may determine whether the command includes a request to transmit a frame in block 124. If it is determined that the command includes a request to transmit a frame, in block 126, the kernel module determines whether the frame to be transmitted fits within a maximum transfer unit (MTU) of the low-level communications protocol. The MTU may include a number of bytes allowed (e.g., 1500) for a frame to be transmitted, a range of bytes (e.g., 1200 to 1600), or another suitable parameter, and may be altered within the kernel module. If the frame to be transmitted exceeds the MTU, in block 110, the application connector from which the command originated may be unregistered. If the MTU is not exceeded, in block 128, the frame indicated by the command may be transmitted to one or more devices on the network (e.g., via the network card driver 71 and network 74 of FIG. 3).

Returning to block 124, if it is determined that the command does not include a request to transmit a frame, the kernel module may determine, in block 130, whether the command includes a request to unregister a connector. If it is determined that the command includes a request to unregister a connector, in block 110, the connector may be unregistered (e.g., to disappear or link down on the outside network). If it is determined that the command does not include a request to unregister a connector, the kernel module may determine if the command corresponds to other networking operations (not illustrated). For example, the kernel module may determine if the command includes a request to block frames from being transmitted to one or more addresses (e.g., IP addresses), to unblock one or more addresses, and so on. In the illustrated embodiment, if it is determined that the command does not include a request to register a snatcher, unregister a snatcher, transmit a frame, or unregister a connector, the connector may be unregistered in block 110.

FIG. 4C illustrates a process 140 for performing additional emulation functions, including routing received frames and routing status information to an application connector. The process 140 may be performed in conjunction with the processes 80 and 100 of FIGS. 4A and 4B. For example, as with block 84 of the process 80 and block 102 of the process 100, block 142 and/or block 144 may be performed following insertion of the kernel module. In block 142, a frame may be received at the kernel module by, for example, identification a frame of low-level communications at the TCP/IP stack of the host operating system. After a frame is received, in block 146, the kernel module determines whether the frame corresponds to a snatcher associated with an application connector (e.g., as registered in block 116 of the process 100). If the received frame corresponds to a snatcher, in block 148, the frame is sent to the application connector identified by the snatcher. Once the frame is sent to the appropriate application connector, the frame is dropped (e.g., such that it does not continue to the system stack of the host operating system).

If the received frame does not correspond to a snatcher as determined in block 146, in block 152, the kernel module determines whether the received frame corresponds to a blocked address. The kernel module may, for example, consult a registry of blocked addresses to determine whether the frame originated from a blocked IP address. That is, by performing block 152, the kernel module may act as a firewall layer for the host operating system and/or connected devices. If the received frame corresponds to a blocked address, the frame is dropped such that it does not continue on to the system stack of the host operating system. If the received frame does not correspond to a blocked address, in block 154, the frame may be forwarded to the system stack for further processing by the host operating system.

Blocks 144 and 156 illustrate an example of additional functionality that may be performed by the kernel module. In block 144, the kernel module may determine or receive an indication that a link status (e.g., communication capability) associated with an application connector has been changed. In response, the kernel module may send the changed link status to the associated application connector in block 156.

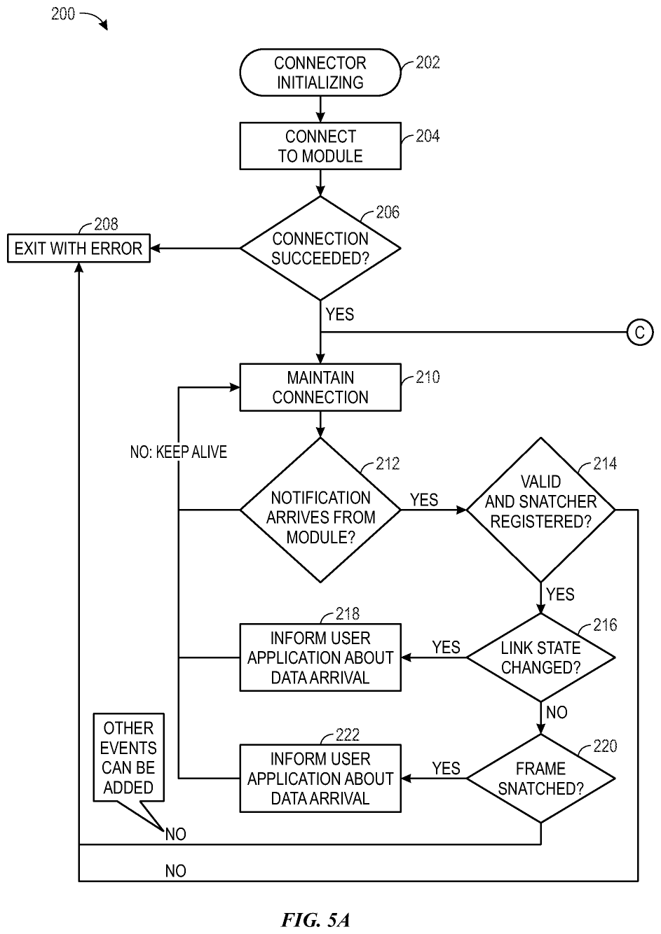

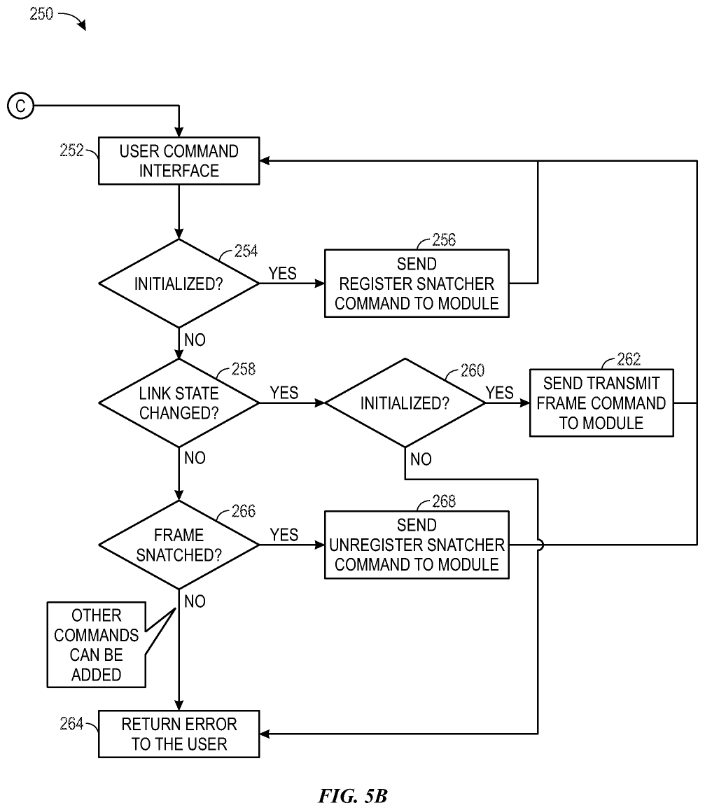

FIG. 5A illustrates a process 200 for receiving data from a kernel module that may be performed by an application connector to emulate an industrial automation device, in accordance with the present embodiments. The process 200 may begin, in block 202, with initializing the application connector. Initializing the application connector may include, for example, an emulator application (e.g., the application 54) referencing a library of the application connector as part of an initialization of a simulated device (e.g., a simulated device 62). Once the application connector is initialized, in block 204, the application connector may connect to the kernel module, which may be performed in conjunction with the kernel module listening for connectors, as in block 84 of the process 80. For example, the application connector may transmit a frame indicative of a command to connect the application connector, and the kernel module may snatch the frame from the TCP/IP stack of the host operating system. In response, the kernel module may register the application connector in a connector registry.

If, in block 206, connection to the kernel module has failed, the application may exit with an error and may, in some instances, present a notification (e.g., visual indication via a user interface) to a user of the application that connection to the kernel module has failed. If, however, the application connector has successfully connected to the kernel module, in block 210, the connection between the application connector and the kernel module may be maintained (e.g., kept alive). While the connection is maintained, in block 212, a notification may arrive at the application connector from the kernel module. The notification may include, for example, a notification of an incoming frame, a notification of link status changes, or other events that the kernel module detects. The application connector may then determine, in block 214, if the notification is valid and a snatcher is registered with the application connector as described herein. The application connector may also determine in block 216 whether the notification includes an indication that a link status between the kernel module and application connector has changed, and may, in block 218, inform the application of the notification of the link status change. If the notification is not indicative of a link status change, in block 220, the application connector may determine whether the notification from the kernel module is indicative of a successfully snatched frame and may, in block 222, inform the application that a frame has been successfully snatched by the kernel module and received at the application connector. Other events may be detected by the kernel module and included with a notification received at the application connector (e.g., firewall events, connection events). If no other event is determined, the application may exit with an error in block 208.

FIG. 5B illustrates a process 250 for interfacing with an application (e.g., the application 54) that may be performed by the application connector during emulation of an industrial automation device. The process 250 may be performed in conjunction with the process 200 by the application connector. For example, block 252 of the process 250 may be performed after it is determined that a successful connection has been established with the kernel module, as illustrated in block 206 of the process 200. In block 252, the process 200 may begin with monitoring for user input received from the application. When user input is received, the application connector may hook to user command interface libraries and/or routines at the application and/or application connector. For example, input at the application by a user (e.g., a button-press or other input provided via a user interface) corresponding to a command may cause the application connector to hook to the user command interface. The input may correspond to a networking operation for a simulated device to be performed by the application connector. In the illustrated embodiment, the application connector may determine whether the command corresponds to an initialize command in block 254. If the command does correspond to an initialize command, in block 256, the application connector may send a register snatcher command to the kernel module. When received by the kernel module, the register snatcher command may be handled as illustrated by block 112 of FIG. 4B, and the process may continue to wait for commands from the application in block 252.

If the command received from the application does not correspond to an initialize command, in block 258, the application connector may determine if the command corresponds to a send frame command. The send frame command may indicate instructions to send a frame to one or more devices on a network of an industrial automation system from a simulated device, for instance. If the received command does correspond to a send frame command, in block 260, the application connector may verify a connection is established with the kernel module, and may include the kernel module verifying that such a connection has been established (e.g., by searching a connector registry). If a proper connection has been established between the application connector and the kernel module, in block 262, the frame is transmitted to the kernel module where it may be handled by the kernel module according to block 142 of FIG. 4C, for instance. The application connector may continue to monitor for commands from the application in block 252. If, however, it is determined by the application connector that a proper connection has not been established, in block 264, the application connector may instruct the application to return an error, which may cause the application to, for example, display an error message to the user.

The command received from the application may also include user input corresponding to a shutdown command. In the illustrated embodiment, if the application connector determines that the received command does not correspond to a send frame command in block 258, the application connector may check for a shutdown command in block 266. If the received command does correspond to a shutdown command, in block 268, the application connector may send an unregister snatcher command to the kernel module and continue to await commands from the application in block 252. In response to the unregister snatcher command, the kernel module may unregister a snatcher associated with the application connector, as illustrated and described in block 122 of FIG. 4B.

As may be appreciated, the commands checked for in blocks 254, 258, and 266 may correspond to examples of user commands that may be received from the application. Other user commands are envisioned and may be added to the process 250, such as commands to block addresses, commands to query the kernel module for a link status, and so on. If a command received from the application does not correspond to a recognized command, in block 264, the application connector may instruct the application to return an error which, as mentioned, may cause the application to display an error message to the user.

While the present disclosure may be susceptible to various modifications and alternative forms, specific embodiments have been shown by way of example in the drawings and have been described in detail herein. However, it should be understood that the present disclosure is not intended to be limited to the particular forms disclosed. Rather, the present disclosure is intended to cover all modifications, equivalents, and alternatives falling within the spirit and scope of the present disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

What is claimed is:

1. A non-transitory computer-readable medium comprising computer-executable instructions that, when executed, are configured to cause processing circuitry to perform operations comprising:
receiving, at a communications stack of an operating system, communications from one or more industrial automation devices;
identifying a subset of the communications, wherein the subset of the communications comprises one or more low-level communication frames;
forwarding the remaining communications to the operating system;
determining a networking operation indicated by the low-level communication frames; and
transmitting the one or more low-level communication frames to one or more simulated industrial automation devices according to the determined networking operation.

2. The non-transitory computer-readable medium of claim 1, wherein the communications are received via one or more network card drivers of the one or more industrial automation devices.

3. The non-transitory computer-readable medium of claim 1, wherein a firmware component of each of the one or more simulated industrial automation devices correspond to a respective firmware component of an industrial automation device.

4. The non-transitory computer-readable medium of claim 1, wherein the one or more simulated industrial automation devices comprise one or more applications.

5. The non-transitory computer-readable medium of claim 4, wherein the one or more applications comprise an application connector, and wherein the one or more low-level communication frames are received at the one or more simulated industrial automation devices via the application connector.

6. The non-transitory computer-readable medium of claim 5, wherein the networking operation is performed by the application connector.

7. The non-transitory computer-readable medium of claim 5, wherein the operations comprise:
receiving, at the communications stack of the operating system, a request to register the application connector; and
adding the application connector to a connector registry based on the request, wherein the one or more low-level communication frames are transmitted to the one or more simulated industrial automation devices based at least on the application connector being present in the connector registry.

8. The non-transitory computer-readable medium of claim 5, wherein the operations comprise:
receiving, at the communications stack of the operating system, a networking command corresponding to a request to transmit a simulated low-level communication frame from the application connector; and
determining whether the simulated low-level communication frame fits within a maximum transfer unit (MTU) of a low-level communications protocol; and
transmitting the simulated low-level communication frame to the one or more industrial automation devices based on the networking command and the determination.

9. The non-transitory computer-readable medium of claim 1, wherein the one or more low-level communication frames comprise one or more Ethernet frames.

10. A system, comprising:
processing circuitry; and
a storage storing code defining:
an operating system; and
a kernel module comprising instructions that, when executed by the processing circuitry, cause the processing circuitry to:
receive, at a communications stack of the operating system, communications from one or more industrial automation devices;
identify a subset of the communications, wherein the subset of the communications comprises one or more low-level communication frames;
forward the remaining communications to the operating system;
determine a networking operation indicated by the low-level communication frames; and
transmit the one or more low-level communication frames to one or more simulated industrial automation devices according to the networking operation.

11. The system of claim 10, wherein the kernel module is configured to be loaded to and unloaded from a kernel of the operating system.

12. The system of claim 10, wherein the one or more simulated devices comprise one or more applications stored in the storage.

13. The system of claim 12, wherein the one or more low-level communication frames are transmitted to the one or more simulated industrial automation devices via an application connector of the one or more applications.

14. The system of claim 13, wherein the application connector is configured to transmit a request to perform a networking operation in response to an application programming interface (API) of the application connector being called by the application.

15. The system of claim 14, wherein the application is configured to call the API of the application connector in response to user input corresponding to the networking operation.

16. A method, comprising:
receiving, at a communications stack of an operating system, communications from one or more industrial automation devices;
identifying a subset of the communications, wherein the subset of the communications comprises one or more low-level communication frames;
forwarding the remaining communications to the operating system;
determining that one or more applications are registered to receive the one or more low-level communication frames; and
transmitting the one or more low-level communication frames to a simulated industrial automation device of each of the one or more applications.

17. The method of claim 16, comprising:
receiving, at a communications stack of an operating system, a request from an additional application to perform a networking operation; and
determining whether the additional application is present in a connector registry; and
performing the networking operation based on the determination that additional application is present in a connector registry.

18. The method of claim 17, wherein the request from the additional application to perform the networking operation comprises an indication of a Media Access Control (MAC) address of the additional application, and wherein determining whether the additional application is present in the connector registry comprises determining whether the MAC address of the additional application is present in the connector registry.

19. The method of claim 17, wherein the networking operation corresponds to user input at a user interface of the additional application.

20. The method of claim 17, wherein the networking operation comprises transmitting an additional low-level communication frame to an industrial automation device of the one or more industrial automation devices.
